(19) United States
(12) Patent Application Publication
(10) Pub. No.: US 2010/0211196 A1
(43) Pub. Date: Aug. 19, 2010

(54) COMMUNICATION MODULE FOR AN AUTOMATION SYSTEM

(75) Inventors: Gernot Gaub, Hockenheim (DE); Brigitte Blei, Berlin (DE); Andreas Wilmers, Heidelberg (DE)

Correspondence Address: DARBY & DARBY P.C., P.O. BOX 770, Church Street Station, New York, NY, 10008-0770, US

(73) Assignee: ABB AG, Mannheim (DE)

(21) Appl. No.: 12/704,855

(22) Filed: Feb. 12, 2010

(30) Foreign Application Priority Data
Feb. 13, 2009 (DE) 10 2009 008 957.8

(51) Int. Cl. G05B 19/04; G06F 13/40; G06F 9/44

(52) U.S. Cl. 700/86; 710/305; 717/124; 711/103; 710/242

(57) ABSTRACT

A communication module includes a processing unit; at least one memory unit cooperating with the processing unit and configured to store a user program; at least two serial interfaces configurable by the user program; and a programming access connectable to a central control unit of an automation system of modular construction and configured to transmit and program the user program.

Priority is claimed to German Patent Application No. DE 10 2009 008957.8, filed Feb. 13, 2009, the entire disclosure of which is incorporated by reference herein.

The invention relates to a communication module, the communication module cooperating with a superordinate control unit (also referred to as a central control unit) of an automation system of modular construction.

### BACKGROUND

Automation systems for controlling a technical process usually comprise a central control unit. The central control unit communicates with the input/output units and/or field devices of the automation system via a communication module.

At present, in order to program the module and to communicate with devices connected to the communication module, the communication modules which are used in automation systems of modular construction have two configurable, DC-isolated serial interfaces which are independent of one another and are in the form of RS232 interfaces.

The serial interfaces are configured by a user program stored in the communication module.

One of the interfaces provided is provided as a programming interface for inputting and testing the user program stored on the communication module. The other interface is an interface which can be configured by the user program.

The user program and user data are stored in a non-volatile memory, for example a flash EPROM.

Transmission and programming of the user program and the user data from the central unit (also called the central control unit) directly into the communication module are not provided in the communication modules currently used in automation systems of modular construction.

### SUMMARY OF THE INVENTION

An aspect of the invention is to specify a communication module for an automation system of modular construction, which communication module relieves the load on the central control unit of the automation system and is suitable, in particular, for transmitting and programming a user program directly from the central unit connected to the communication module into the communication module.

The communication module according to the invention for an automation system of modular construction includes a processing unit which is preferably in the form of a microprocessor, a non-volatile memory unit which cooperates with the latter and is intended to store a user program, and at least two configurable, DC-isolated serial interfaces which are independent of one another, can be configured by the user program stored in the memory unit and are intended to assume functions of the interfaces of a central control unit connected to the communication module if said interfaces do not suffice.

According to the invention, the communication module is set up to execute different communication protocols, the drivers required for this purpose being stored in the memory unit of the communication module.

In one preferred embodiment of the communication module according to the invention, the memory unit comprises at least two memories which are in the form of a flash EPROM and a RAM and are intended to store both the user program and user data and to provide them to the processing unit for execution.

One of the serial interfaces is preferably provided as a programming interface for inputting and testing the user program stored on the communication module, and the further serial interface is in the form of an interface which can be configured by the user program.

In one advantageous embodiment of the communication module according to the invention, the serial interfaces each have at least two physical interfaces, the first physical interface being able to be in the form of an RS232 interface, for example, and the second physical interface being able to be in the form of an RS485 interface (for example for multidrop bus applications).

Furthermore, the serial interfaces are exclusively in the form of an RS232 interface or an RS485 interface or an RS422 interface, the different interfaces of the communication module being able to have the same design or a different design.

In one particular embodiment of the communication module according to the invention, the serial interfaces are in the form of an RS232 interface or an RS485 interface or an RS422 interface or an Ethernet interface, the different interfaces of the communication module being able to have the same design or a different design.

The freely configurable serial interfaces are intended to transmit different protocols, for example Modbus, CS31 bus, RCOM, RCOM+, COMLI, EPVS, SysLibCom and/or Multi (changeover between two different protocols, for example Modbus, ASCII, SysLibCom).

Information interchange by the communication module via its serial interfaces can advantageously also be carried out using the standard code ASCII (American Standard Code for Information Interchange).

According to the invention, the user program can be programmed via an additional programming access of the communication module, the programming access being in the form of a dual-port RAM (DPR), for example, and being directly connected to the central control unit of the automation system.

As a result of the additional programming access to the central control unit, it is advantageously possible to use a single programming tool for the central unit and the communication module.

### BRIEF DESCRIPTION OF THE DRAWINGS

The invention as well as advantageous refinements of and improvements to the invention shall be described and explained in more detail using the exemplary embodiments illustrated in the following figures, in which:

FIG. 1 shows one exemplary embodiment of the communication module according to the invention, and

FIG. 2 shows another exemplary embodiment of the communication module according to the invention.

### DETAILED DESCRIPTION

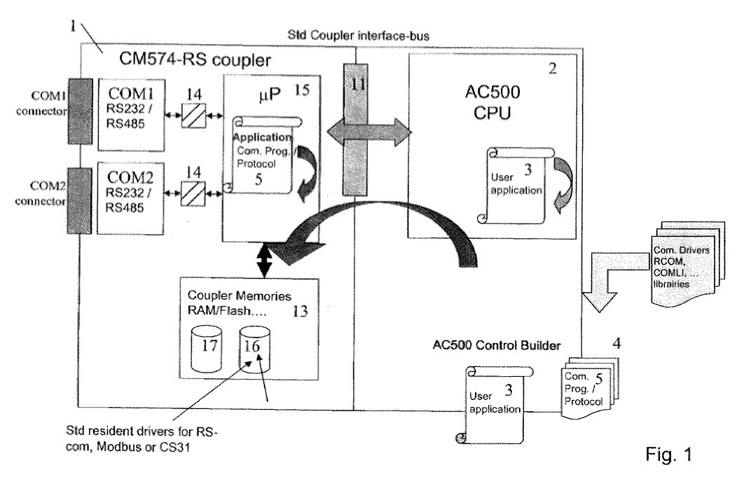

FIG. 1 shows one embodiment of the communication module 1 according to the invention for an automation system of modular construction, having a microprocessor 15 for executing a user program 5, having a memory unit 13 which cooperates with said microprocessor and is constructed from a non-volatile memory 16 and a volatile memory 17, with the user program 5, user data, communication protocols 5 and communication programs 5, for example, being stored in the first memory 16 which is in the form of a flash EPROM and with standardized drivers for serial interfaces COM1, COM2 provided in the communication module 1 and for different protocols, for example Modbus or CS31 bus, being stored in the memory 16. The user programs 5, user data, communication protocols 5, communication programs 5 and drivers stored in the memory 16 are loaded into the RAM memory 17 for execution and are provided to the microprocessor 15 for processing.

The microprocessor 15 is connected to two configurable, serial interfaces COM1, COM2 which are independent of one another and are intended to transmit data, in particular to program the communication module 1 and to communicate with devices connected to the communication module 1. The first interface COM1 and the second interface COM2 are DC-isolated from one another, the DC-isolation being able to be effected, for example, using two digital isolators 14.

The first interface COM1 is provided as a programming interface for inputting and testing the user program 3 stored on the communication processor 1, and the second serial interface COM2 is in the form of an interface which can be configured by the user program 3.

According to the invention, in addition to a first physical interface RS232, the serial interfaces COM1, COM2 each have a further physical interface RS485, for example for multidrop bus applications. The interfaces are intended for standard protocols, for example ASCII, Modbus, CS31 bus, RCOM, RCOM+, COMLI, EPVS, SysLibCom and/or Multi (changeover between two different protocols, for example Modbus, ASCII, SysLibCom).

In one particular embodiment of the communication module according to the invention, one or more of the serial interfaces are configured as a CS31 bus interface, process data from input/output devices connected to the CS31 bus interfaces being provided to the central unit 2 via the programming access 11 according to a configuration of the user program 3.

In another embodiment of the communication module according to the invention, one or more of the serial interfaces are configured as a Modbus interface or another fixed protocol interface, and the data from the input/output devices connected to the serial interfaces are transmitted to the central unit 2 via the programming access 11 according to the configuration of the user program 3.

The user program 5 can be programmed via an additional programming access 11 of the communication module 1, the programming access 11 being connected to a central control unit 2 of the automation system via a dual-port RAM (DPR), for example. The communication module 1 and the central control unit 2 can therefore be programmed using a single programming tool 4.

The programming tool 4 is a programming tool for programming programmable logic controllers (PLC). The communication module is thus advantageously programmed like a PLC according to IEC61131. It is thus possible to store a PLC user program in the communication module, which program is connected to decentralized input/output devices via the interfaces COM1, COM2 in order to acquire process data or to drive actuators.

The programming languages and instructions and libraries and debug options provided in the programming tool 4 can be used in the same manner for the communication module 1 and the central unit 2.

The communication module 1 is also intended to communicate with the user program 3 of the central unit 2 via the dual-port RAM (DPR) 11 using cyclically configurable input/output data and/or acyclically using so-called messages.

In one particular embodiment of the communication module according to the invention, the serial interfaces are in the form of an RS232 interface or an RS485 interface or an RS422 interface or an Ethernet interface, the different interfaces of the communication module being able to have the same design or a different design.

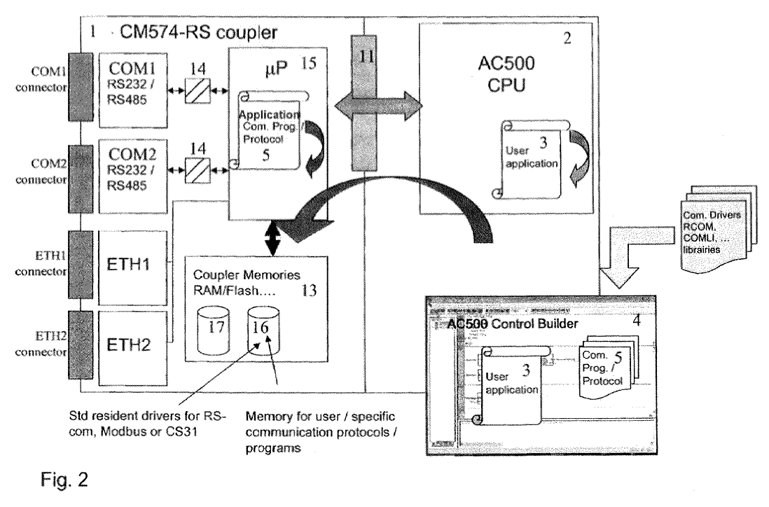

FIG. 2 shows another embodiment of the communication module 1 according to the invention, which differs from the embodiment of the communication module 1 according to FIG. 1 in that the serial interfaces COM1, COM2 may also be in the form of an Ethernet interface ETH1, ETH2.

What is claimed is:

1. A communication module comprising:
a processing unit;
at least one memory unit cooperating with the processing unit and configured to store a user program;
at least two serial interfaces configurable by the user program; and
a programming access connectable to a central control unit of an automation system of modular construction and configured to transmit and program the user program.

2. The communication module as recited in claim 1, wherein the at least two serial interfaces each include a RS232 interface and at least one of a RS485 interface and a RS422 interface.

3. The communication module as recited in claim 1, wherein the at least two serial interfaces are in a form of one of a RS232 interface, a RS485 interface and a RS422 interface.

4. The communication module as recited in claim 1, wherein the at least two serial interfaces are in a form of at least one of a RS232 interface, a RS485 interface, a RS422 interface and an Ethernet interface.

5. The communication module as recited in claim 1, wherein the programming access includes a dual-port RAM.

6. The communication module as recited in claim 1, wherein the central control unit is configured to program the communication module unit via the programming access using a programming tool.

7. The communication module as recited in claim 6, wherein the programming tool includes programming languages, libraries and debug options usable to program the communication module.

8. The communications module as recited in claim 2, wherein the at least two serial interfaces each include a configurable, DC-isolated interface and are independent of one another.

9. The communication module as recited in claim 1, wherein the memory unit includes at least one of a non-volatile flash EPROM and a RAM.

10. The communication module as recited in claim 1, wherein one of the at least two serial interfaces is a programming interface configured to input and test the user program, and wherein at least one of the at least two serial interfaces is configurable by the user program.

11. The communication module as recited in claim 1, wherein the at least two serial interfaces are configurable by the user program.

12. The communication module as recited in claim 1, further comprising an input/output device, wherein at least one of the at least two serial interfaces is configured as a CS31 bus interface connected to the input/output device, and wherein process data from the input/output device are available to the central control unit via the programming access in a configuration of the user program.

13. The communication module as recited in claim 1, further comprising an input/output device, wherein at least one of the at least two serial interfaces is configured as one of a Modbus interface and a fixed protocol interface, and wherein data from the input/output device connected to the serial interface are available to the central control unit via the programming access in a configuration of the user program.

14. The communication module as recited in claim 6, wherein the programming tool is configured to program a plurality of programmable logic controllers, and wherein the programming tool is configured to program the communication module according to IEC 61131 via the programming access.

15. The communication module as recited in claim 1, further comprising a programmable logic controller user program stored in the communication module and configured to communicate with a decentralized input/output device via the two serial interfaces so as to acquire process data or drive actuators, and wherein the input/output device is decentralized.

16. The communication module as recited in claim 7, wherein at least one of the programming languages, instructions, libraries and debug options of the programming tool are usable by the communication module and the central control unit.

17. The communication module as recited in claim 1, wherein the communication module is configured to communicate with the user program via the programming access using cyclically configurable input/output data and/or acyclically using messages.
